(19) United States
(12) Patent Application Publication
(10) Pub. No.: US 2025/0162744 A1
(43) Pub. Date: May 22, 2025

(54) SYSTEM AND METHOD FOR PACKAGING FOOD PRODUCTS

(71) Applicant: Weber Food Technology GmbH, Breidenbach (DE)

(72) Inventors: Andreas Dietrich, Biedenkopf (DE); Andreas Runkel, Biedenkopf (DE); Karsten Roth, Steffenberg (DE)

(21) Appl. No.: 18/835,217

(22) PCT Filed: Jan. 18, 2023
(86) PCT No.: PCT/EP2023/051135

§ 371 Date: Aug. 1, 2024

(30) Foreign Application Priority Data
Feb. 4, 2022 (DE) 10 2022 102 713.9
Oct. 28, 2022 (DE) 10 2022 128 659.2

(51) Int. Cl. B65B 25/06; A22C 17/00; B25J 15/08; B26D 3/24; B65B 5/02; B65B 5/06; B65B 35/58; B65B 43/46; B65B 49/14; B65B 57/02; B65B 57/10; B65B 61/18; B65B 65/00; B65D 33/16

(52) U.S. Cl. CPC B65B 25/065; A22C 17/0093; B25J 15/08; B26D 3/24; B65B 5/02; B65B 5/06; B65B 35/58; B65B 43/46; B65B 49/14; B65B 57/02; B65B 57/10; B65B 61/188; B65B 65/006; B65D 33/16; B65B 2210/02; B65B 2220/22

(57) ABSTRACT

A system for processing food products comprises a cutting apparatus for cutting off slices from the food products and for forming portions from the slices, a packaging machine, and a transport apparatus that transports the portions from the cutting apparatus to the packaging machine. Furthermore, the system comprises a provision device for providing portion supports for the transported portions, and a folding device that is configured to fold a portion support along a bending line. The system further comprises an insertion device by means of which the portion supports with the portions can be brought onto a packaging space such that the bending lines of the portion supports are aligned in parallel with a transport direction of the packaging machine.

### RELATED APPLICATIONS

The present application is a national stage application under 35 U.S.C. § 371 of International Application No. PCT/EP2023/051135, filed 18 Jan. 2023, which claims priority from German Patent Application No. 10 2022 102 713.9, filed 4 Feb. 2022 and German Patent Application No. 10 2022 128 659.2, filed 28 Oct. 2022. The above-referenced applications are incorporated by reference.

### SUMMARY

The invention relates to a system for processing food products, in particular meat products and/or pieces of bacon. The system comprises at least one cutting apparatus that has a product feed and at least one blade arranged in a cutting plane, wherein the product feed is configured to guide food products on one track or multiple tracks into the cutting plane, and wherein the blade is configured to cut off slices from the food products guided into the cutting plane and to form portions from the cut-off slices, said portions comprising one or more slices. Furthermore, the system comprises a packaging machine, in particular a deep-draw packaging machine, that is configured to provide respective packaging spaces for the portions and to move said packaging spaces along a transport direction; and a transport apparatus that is configured to transport the portions from the cutting apparatus along a transport path to the packaging machine. A provision device is further arranged at the transport path and is configured to provide portion supports, in particular L-boards, for the transported portions such that the portions transported by the transport apparatus along the transport path may be placed on a placement section of a respective portion support, wherein the respective portion support has a marginal section that is not covered by the placed portion.

Such systems may in particular be provided to process supplied food products, for example bar-shaped meat products or pieces of bacon, into products ready for sale in that the food products may be cut into slices by a cutting apparatus, portions may be formed from the slices, and the portions may be fed to a packaging machine and packaged by the packaging machine to be able to offer the products portioned and packaged for sale. Furthermore, it may be provided that the portions formed by or at the cutting apparatus are placed on a provided portion support, which may, for example, be intended to enable an easier removal of the portion from the packaging, during the transport along a transport path and before reaching the packaging machine.

However, so-called L-boards that have a marginal section that may be folded down may in particular be provided as portion supports, wherein such a marginal section may in particular be folded down in the course of the processing of the foods such that an upper side of a packaged portion is at least partly covered by the folded-down marginal section. A buyer of the packaged product may therefore recognize both the uncovered part of the portion upper side and the marginal section so that the buyer may inspect the product, on the one hand, while, for example, product information and/or advertising elements may also be presented to the buyer on the folded-down marginal section, on the other hand. Furthermore, a packaged portion may be at least partly surrounded at both sides by the portion support by folding down a marginal section so that the portion may, for example, be removed from the packaging by gripping the portion support without having to contact the portion or a slice directly. It is in particular known to use such L-boards when packaging pieces of bacon that are cut and portioned into slices.

When processing food products in this way, it is generally endeavored to achieve an as high as possible product throughput. Therefore, so-called high-speed slicers are often used as cutting apparatus and may achieve speeds of several hundred to several thousand cuts per minute. Furthermore, high-speed slicers may also be configured to cut off slices from products fed on multiple tracks, wherein the transport apparatus arranged downstream and the packaging machine may generally likewise be configured to simultaneously handle portions in multiple tracks. A packaging machine may in particular be configured to provide packaging spaces disposed next to one another in a cycle so that a plurality of portions may be brought onto respective packaging spaces during a cycle of the packaging machine.

Whereas in particular cutting apparatuses are thus known that achieve suitably high cutting speeds and a high portion throughput, it is necessary with existing systems, in which L-boards comprising a marginal section that may be folded down are used, to manually fold down the marginal section. After the folding down, the product support with the placed portion must furthermore be placed onto the transport apparatus again such that the folded-down marginal section is oriented perpendicular to a transport direction of the transport apparatus and towards the packaging machine to be able to keep the marginal section in the folded-down state during the further transport towards the packaging machine, for example by belts extending above the transport apparatus and along the transport direction, and to prevent the portion support from unfolding.

However, the manual folding is in particular associated with a high personnel and time expenditure, whereby the product throughput to be achieved with such systems is ultimately limited compared to the output that may in principle be achieved by the cutting apparatus. Furthermore, in existing systems, due to the necessary manual access to the transported portions—which usually has to take place from a predefined operating side—, the transport apparatus may be designed with at most two tracks, whereby the portion throughput is limited again.

Furthermore, the products to be sliced usually have an approximately rectangular cross-sectional shape so that the cut-off slices are also approximately rectangular and are formed with a long side and a short side. To be able to position portions formed from such slices on portion supports, the portion supports must also have a corresponding shape, at least in the folded-down state of the marginal section, so that the long side of the portion support must be oriented perpendicular to the transport direction of the transport apparatus in order, after the folding, to be able to transport the portion support with the marginal section at the front at the transport apparatus and to secure the marginal section against an unfolding. However, this orientation of the portion support requires a relatively wide design of the system.

Since a transport direction of the packaging machine furthermore usually corresponds to the transport direction of the transport apparatus, the packaging machine must also be relatively wide, even in a two-track operation, to be able to provide packaging spaces with a long side that is likewise oriented perpendicular to the transport direction and to be able to pick up the portions. In practice, at most two packaging spaces disposed next to one another may therefore be provided in existing systems since a width of the packaging machine going beyond this cannot ultimately be realized in view of the existing space conditions in a production hall and the design and technical limitations of the configuration of a packaging machine. However, since a clock speed of the packaging machine is usually significantly lower than the portion throughput of the cutting apparatus, this also means that the performance of the cutting apparatus cannot be fully utilized, but rather only a reduced product throughput may be achieved.

Furthermore, the flexibility in the processing of the food products is also limited to the extent that, when using L-boards, only food package arrangements comprising two mutually connected individual food packages may be produced to be able to offer such food package arrangements or multiple portions for sale. However, a larger number of mutually connected food packages or an odd number of mutually connected food packages cannot be produced in existing systems.

It is therefore an object of the invention to provide a system for processing food products, in which the food products may be placed on portion supports and a marginal section of the portion support may be folded down, wherein, however, a higher product throughput and a greater flexibility may be achieved compared to the existing systems described. Furthermore, a better utilization of a width of a material web moved by the packaging machine to provide the packaging spaces is to be made possible.

This object is satisfied by a system having the features of claim 1.

In this system, it is first provided that a transition between the placement section and the marginal section of the respective portion support defines a bending line of the respective portion support. The system furthermore comprises a folding device that is configured to fold the respective portion support along its bending line, and an insertion device that is configured to bring the respective portion support with the placed portion onto the provided packaging space such that the bending line of the inserted portion support is aligned in parallel with the transport direction of the packaging machine.

The provision of a folding device at the system makes it possible to fold the bending lines of the portion supports automatically—by the folding device—so that a manual folding of the marginal section is no longer necessary. Rather, an automated processing of the food products may be achieved without manual steps for folding down the marginal section that are associated with a corresponding high personnel and time expenditure being required so that the processing may be accelerated and the product throughput may be increased compared to a conventional system. The folding device may generally be configured to fold the respective portion support along its bending line after placing the associated portion.

Furthermore, the folding down of the marginal section may be standardized in that the portion supports have a bending line defined by the transition between the placement section and the marginal section and the folding of the portion support by the folding device may always take place at the same position. A consistent quality of the folding may also be ensured by such a standardized process and the susceptibility to error may be reduced compared to a manual folding since the folding may be performed exactly the same way for each portion support or portion. For example, the bending line may be defined by a spacing from an outer margin of the portion support so that each portion support may have a marginal section of the same width.

Since the system further has an insertion device by means of which the portion supports with the placed portions may be brought onto a respective provided packaging space such that the bending line of the portion support is aligned in parallel with the transport direction of the packaging machine, it may moreover be achieved that a portion support brought onto a packaging space is oriented with a short side perpendicular to the transport direction of the packaging machine, whereas a long side of the portion support, along which the bending line may in particular extend, may be aligned in parallel with the transport direction. The required width of a packaging space in relation to a transverse direction oriented perpendicular to the transport direction may thus be determined by the length of a short side of a portion support, whereas in conventional systems it is the long side of the portion support that is oriented transversely to the transport direction of the packaging machine, and the packaging spaces must therefore have a correspondingly greater width. The insertion of the portion supports into the packaging machine such that the bending line is aligned in parallel with the transport apparatus thus makes it possible to reduce the width of the packaging machine and/or to package a larger number of portion supports with placed portions next to one another with respect to the transverse direction in that a larger number of packaging spaces may be provided next to one another without the packaging machine having to have a width that exceeds a common width that is appropriate considering the usually available space. In particular, by inserting the portion supports in this way, it may be achieved to be able to package three portion supports with placed portions next to one another in the transverse direction and, for example, to also be able to manufacture food package arrangements that comprise three mutually connected food packages in which a respective portion support with a placed portion is packaged. In such food package arrangements, three individual food packages may thus ultimately be attached to one another, wherein, in some embodiments, a perforation may further be formed in the two intermediate regions between respective food packages to be able to present the food package arrangement to the customer folded into a bundle and in a compact form. The manufacture of such food package arrangements in particular also makes it possible to manufacture food package arrangements for discount campaigns such as the widespread “buy three, pay two”.

While the insertion device is thus configured to bring the portion supports onto a respective packaging space such that the bending line is aligned in parallel with the transport apparatus, it may be provided that the provision device is configured to provide the portion supports in an orientation in which the bending line is oriented perpendicular to the transport direction of the packaging machine. In particular, the system as a whole may extend along the transport direction of the packaging machine and the portions as well as the portion supports may be transported by means of the transport apparatus along the transport direction of the packaging machine so that the portion supports may be provided in an orientation in which the bending lines are oriented perpendicular to the transport direction of the transport apparatus and therefore perpendicular to a direction along which the portions are moved during the placing on the portion supports.

Such a provision of the portion supports may in particular simplify the placing of the portions since the food products are usually fed to the blade lying on the product feed with a long side, in relation to a cross-section, so that long sides of the cut-off slices may also be oriented perpendicular to the transport direction. In this regard, the portion supports may be provided such that the bending lines are aligned in parallel with the long sides of the portions so that the portions only have to be moved over a distance corresponding to the short side in order to be able to be placed on the portion supports.

To nevertheless be able to bring the portion supports with the placed portions onto the provided packaging spaces such that the bending lines are aligned in parallel with the transport direction, the insertion device may, for example, comprise a turning device. For example, the insertion device may comprise a robot gripper for gripping provided portion supports and portions and may be configured to grip and to rotate, in particular by 90°, a portion support oriented perpendicular to the transport direction of the packaging machine in order to then bring the portion support onto the provided packaging space. Furthermore, it may also be provided that the transport apparatus comprises a turning device so that the portion supports with the placed portions may already be rotated during transport and provided at the insertion device in an orientation in which the bending lines of the portion supports are aligned in parallel with the transport direction of the packaging machine. Furthermore, the transport apparatus and the insertion device may also have a turning device so that the portion supports may be rotated partly at the transport apparatus and partly at the insertion device to be able to ultimately align the bending lines in parallel with the transport direction of the packaging machine.

However, it may generally also be provided that the provision device is configured to already provide the portion supports in an orientation in which the bending lines are aligned in parallel with the transport direction of the packaging machine. For this purpose, provision may, for example, be made that the portions may be transported from the transport apparatus to the packaging machine perpendicular to a direction along which the products are guided into the cutting plane so that slices that have been cut off from products lying on a long side and guided into the cutting plane may be transported along the transport path with the short side at the front. The long side of the slices or portions may therefore be moved in parallel with the transport direction of the transport apparatus and in particular also of the packaging machine so that a bending line of a portion support provided with a bending line aligned in parallel with the transport direction may be aligned in parallel with the long side of the portion and the portion may be placed on the portion support accordingly.

The provision device may, for example, comprise a stacking section in which a stack of portion supports is provided, wherein a removal device of the provision device may be configured to remove a respective uppermost portion support from the stack and to transfer it to a guide, for example one or more band conveyors, by means of which the portion support may be guided to the transport path.

Furthermore, the folding device may, for example, be at least partly arranged at or along the transport path so that the marginal section may, for example, be at least partly folded down already during the transport along the transport path. Furthermore, it may be provided that the folding device comprises the insertion device so that the portion support may be at least partly folded along its bending line during the insertion into the packaging machine. Furthermore, the packaging machine may also comprise at least a part of the folding device and the marginal section may, for example, only be completely folded down during the movement in the packaging machine.

The insertion device may, for example, comprise a robot gripper, in particular a so-called picker robot, that is configured to grip portions and portion supports, which are fed by means of the transport apparatus, and to bring them onto a respective packaging space. Alternatively thereto, it may, however, also be provided that the insertion device comprises a so-called feeder and in particular has a transport band from which fed portions may be transferred to the packaging machine and brought onto respective packaging spaces. In particular, in some embodiments, the insertion device may thus comprise a final section and/or a final transport band of the transport apparatus. The insertion device may generally be configured to insert a respective portion support with the placed portion into the packaging machine and/or to transfer it to the packaging machine.

The packaging machine may, for example, be a deep-draw packaging machine in which a material web is moved along the transport direction and depressions are made in the material web at a molding station and form the packaging spaces. The insertion device may therefore be configured to bring portion supports with placed portions into such packaging depressions. The packaging machine may then be configured to move the depressions with the inserted portions to a sealing station at which the depressions are sealed with a supplied upper material web. Furthermore, the packaging machine may have a separating station which is arranged downstream of the sealing station and at which packages guided next to one another and/or behind one another may be separated from one another. For this purpose, the separating station may in particular comprise blades arranged along and/or perpendicular to the transport direction. The material web and/or the upper material web may in particular be films composed of plastic, wherein paper webs and/or material webs composed of organic materials may, however, also be used.

As an alternative to a configuration as a deep-draw packaging machine, it may also be provided that the packaging machine is configured to provide packaging bases and/or so-called trays into which the portion supports with the placed portions may be inserted by means of the insertion device. It may furthermore be provided that the packaging machine provides a material web, wherein the insertion device may be configured to place the portion supports with the placed portions at respective defined locations on the material web that may form the packaging spaces in this regard. In the case of packaging machines that provide trays, packaging bases or defined spaces on a material web as packaging spaces, provision may, however, also be made to seal the packages at a downstream sealing station by an upper material web and/or to separate the packages.

In particular, the system as a whole may extend along the transport direction of the packaging machine so that the food products may already be guided into the cutting plane along the transport direction, possibly inclined with respect to a horizontal transport direction, and/or may be transported by the transport apparatus along the transport direction.

Furthermore, a long or short side is always to be understood in the context of the present disclosure such that a respective side that is longer or shorter relative to another side is described.

Further embodiments are explained in the dependent claims, in the description, and in the drawings.

In some embodiments, the portion support may be formed from board, cardboard, paper and/or foil. Furthermore, in some embodiments, the marginal section may have one or more viewing windows and/or, in the completely folded state of the portion support, may cover a portion upper side that is opposite a portion underside that lies on the placement section of the portion support. The folded portion support may thus in particular engage around a placed portion when the marginal section is folded down.

The portion support may be planar in the non-folded state in some embodiments. The portion support may thus in particular be a flat support on which a portion may be placed and which may support the placed portion at a portion underside.

In some embodiments, the portion support may be at least substantially rectangular and/or substantially square. Furthermore, in some embodiments, the portion support may have a short side and a long side and may in particular be rectangular, wherein the bending line may extend parallel to the long side. In particular, in some embodiments, the placement section may have a long side and a short side and/or may be at least substantially rectangular. Furthermore, in some embodiments, the marginal section may have the same length as the placement section so that the bending line may extend along the entire length of the placement section, or the placement section may have a length that is in particular slightly greater than the marginal section. In embodiments in which the placement section has a greater length than the marginal section, the marginal section may in particular extend beyond the bending line at two sides of equal length. The portion support may therefore also have an at least substantially rectangular or square shape in a configuration of the portion support in which the placement section is slightly longer than the marginal section. The portion support may furthermore have pointed or rounded corners and/or the marginal section may have a smaller width than the placement section. Furthermore, the placement section may occupy a larger area than the marginal section.

Since the bending line may in particular extend along a long side of the portion support, the space occupied by a portion support at the packaging machine may be minimized perpendicular to the transport direction by inserting the portion support such that the bending line is aligned in parallel with the transport direction. Furthermore, even in a square design of the portion support, the placement section may ultimately have a rectangular shape with a long side and a short side, wherein the bending line extends along the long side of the placement section. The space occupied by the portion support in the packaging machine transverse or perpendicular to the transport direction may thus also be limited to the short side of the placement section in such embodiments. This in particular makes it possible to provide a plurality of packaging spaces next to one another without requiring an unreasonable width of the packaging machine so that a plurality of portions may be simultaneously processed and, for example, food package arrangements may be manufactured that comprise three food packages with respective packaged portions, said food packages being disposed next to one another and connected to one another at their respective long sides.

In some embodiments, the bending line may be formed by a fold, wherein the fold may in particular be perforated. Alternatively thereto, in some embodiments, the portion support may, however, also be formed uniformly in the non-folded state and may in particular have a constant thickness, wherein the bending line may be defined by a predetermined spacing from an outer margin of the portion support, said outer margin facing away from the placement section.

The bending line may therefore, for example, already be visible as a material weakening before the folding or only after the folding. However, the folding may always take place at a defined spacing from an outer margin of the portion support that faces away from the placement section, and thus in a standardized form. However, it may generally also be provided that a width of the marginal section and in this regard the spacing between the outer margin and the bending line may be predefined by a setting of the folding device so that, for example, the surfaces of the placement section and the marginal section may be adaptable in dependence on the respective processed products. Here, too, the bending line may, however, be defined by a spacing from the outer margin that corresponds to the respective setting of the folding device.

A uniform portion support may in particular have a constant thickness, whereas a fold may represent a material weakening. For example, a fold may be formed by pressing in the portion support along the bending line or by pre-folding the portion support. Furthermore, a fold may in particular have a perforation. A fold may generally be provided to facilitate the folding of the portion support along the bending line and to prevent the portion support from being folded along a line deviating from the bending line.

In some embodiments, in the folded-down state of the portion support, the marginal section of the portion support may extend along a portion upper side that is opposite a portion underside with which the portion lies on the placement section. In this regard, provision may in particular be made to completely fold over the marginal section of the portion support, wherein the folded-over marginal section may at least sectionally cover the portion upper side. In such embodiments, the placement section may thus support the portion underside and the portion support may engage around the placed portion at both sides.

In particular, such a folding downof the marginal section may make it possible to present a portion in a packaging such that a customer may perceive the uncovered part of the portion upper side and the folded-down marginal section on which product information and/or advertising elements may be applied, for example. The customer may thus himself examine the offered product, on the one hand, and, on the other hand, obtain information about the product without having to turn the packaging. Furthermore, such an engaging around of a portion by the portion support may enable the customer to remove the portion from a packaging without having to contact the portion, in particular neither the portion underside nor the portion upper side or an upper or lower slice, respectively.

In some embodiments, the insertion device may be configured to bend the marginal section of the portion support by approximately 90 degrees, in particular by at least 90 degrees and/or by exactly 90 degrees, during the insertion.

In this regard, in such embodiments, the folding device may comprise the insertion device and at least a part of the folding down of the marginal section may take place during the insertion into the packaging machine. For example, provision may be made to bend the marginal section by approximately 90 degrees, for example at least 85 degrees, and in particular at least 90 degrees or exactly 90 degrees, during the insertion into the packaging machine, whereupon the marginal section may be folded down further, for example during a subsequent movement in the packaging machine, to ultimately be able to be arranged in a manner covering the portion upper side. In this regard, the packaging machine may in particular also comprise a part of the folding device.

In some embodiments, the insertion device may comprise a robot gripper that is configured to grip portions transported by the transport apparatus into an insertion section and to bring them onto the packaging spaces. In such embodiments, a bending device, in particular a web, may further be arranged at the packaging machine and the robot gripper may be configured to bring the marginal section of the portion support into contact with the bending device during the insertion of the portion and, as a result, to bend said marginal section by approximately 90 degrees, in particular at least or 90 degrees or exactly 90 degrees, during the insertion.

In particular, in such embodiments, it may be provided that the robot gripper is configured to grip a portion support transported into the insertion section in order to bring the portion support together with the placed portion onto a packaging space. For this purpose, the robot gripper may, for example, grip the portion support at two sides oriented perpendicular to the bending line and may lift it from the transport apparatus to be able to transfer the portion support to the packaging machine and lower it onto a packaging space. During the lowering, the robot gripper may in particular bring the portion support into contact with the bending device or a web arranged at the packaging machine, in particular arranged above a provided packaging space, such that the marginal section bends along the bending line and is bent by approximately 90 degrees or by at least 90 degrees or by exactly 90 degrees after the insertion into the packaging machine. For this purpose, the bending line may in particular first be arranged in alignment with an edge of the bending device and guided along the bending device during the lowering so that the marginal section may so-to-say be displaced by the bending device. The bent marginal section may therefore in particular be arranged at a wall of a packaging depression.

Furthermore, in some embodiments, the robot gripper may have a holding edge that fixes the bending line during the insertion. It may in particular be achieved by such a holding edge that a force acting on the marginal section due to the interaction of the robot gripper with the bending device is compensated at the bending line so that the marginal section bends exactly at the bending line. For example, such a holding edge may be formed by a metal sheet that extends perpendicular to a plane of the placement section and that is aligned in parallel with the bending line when the robot gripper grips the portion support. The holding edge may in particular be configured to contact the bending line at an upper side of the portion support on which the portion is placed. Furthermore, in some embodiments, the robot gripper may be configured to support an underside of the portion support to be able to prevent a deviation of the bending line on a contact with the bending device.

In some embodiments, the robot gripper may comprise at least two claw-like gripper elements that are configured to grip beneath the portion support at respective sides oriented perpendicular to the bending line. Furthermore, the gripper elements may have contact sections extending perpendicular to a plane of the placement section, in particular to be able to prevent the portion from slipping off the portion support during the insertion into the packaging machine. Such contact sections may further serve to push portions that protrude slightly laterally beyond the placement section onto the placement section and, as a result, to correct an orientation of the portions.

In some embodiments, the insertion device and/or the transport apparatus may comprise a transport device, in particular a transport band, and the folding device may have a motion link which is arranged at the transport device and by means of which the marginal section of the portion support may be pivoted during transport, in particular by approximately 90 degrees and/or at least 85 degrees and/or at least 90 degrees. Furthermore, in some embodiments, the marginal section may be pivotable by exactly 90 degrees by the motion link.

For example, the transport device may be a feeder that is configured to bring provided portion supports with portions placed thereon onto associated packaging spaces. The transport device may therefore in particular be a transport band facing the packaging machine, for example a wide, continuous transport band or a transport band comprising a plurality of parallel belts, from which the portion supports with the placed portions are inserted into the packaging machine. For this purpose, the portion supports with the placed portions may in particular be guided via a deflection of a continuously revolving transport band, said deflection facing the packaging machine, and transferred to the packaging machine. Such a transport device may therefore be understood both as part of the transport apparatus and as part of the insertion device.

Since the folding device may comprise a motion link arranged at the transport device, the marginal section of the portion support may already be pivotable during the transport to the packaging machine, in particular by approximately 90 degrees. For example, the motion link may for this purpose have a contact section, which increasingly tilts towards a vertical in relation to a horizontal along the transport direction, and may be arranged such that the marginal section comes into contact with the contact section of the motion link during the transport by the transport device so that the marginal section may be increasingly pivoted towards the vertical. This may in particular be provided in the case of systems in which the portion supports already arrive on the transport device in an orientation in which the bending line is aligned in parallel with the transport direction. This may in particular be achieved if the system comprises a turning device arranged at the transport apparatus for rotating the portion supports or if the portion supports are provided in bending lines aligned in parallel with the transport direction by the provision device, as already mentioned above.

In such embodiments, the portion supports may further in particular leave the transport apparatus with a marginal section pivoted by approximately and/or at least 90 degrees. For example, the portion supports may be brought directly from the transport device onto the packaging spaces with the marginal section pivoted by approximately, at least or exactly 90 degrees. Furthermore, in such embodiments, the packaging machine may also comprise the aforementioned bending device so that the already pivoted marginal section may be guided along the bending device during the insertion into the packaging machine and the portion support cannot unfold.

However, it is also possible for a robot gripper of the aforementioned kind to adjoin the transport device with the motion link in order to insert the portion supports with the placed portions into the packaging machine. Due to the aforementioned motion link, such a robot gripper may therefore grip the portion supports with the marginal section already folded down by approximately, at least or exactly 90 degrees, wherein the robot gripper in such embodiments may in particular have a holding edge that is configured to support the marginal section from the outside during the insertion into the packaging machine and, as a result, to counteract an unfolding of the portion support.

In some embodiments, the portions may be able to be transferred from the transport device to the packaging machine and brought onto the packaging spaces. In this regard, the transport device may in particular be a feeder and/or the insertion device may comprise the transport device.

In some embodiments, the folding device may have a fold-down link that is arranged at the packaging machine and that is configured to fold down the marginal section of the portion support as a result of the movement along the transport direction. The fold-down link may in particular be configured to completely fold down the marginal section of the portion support as a result of the movement along the transport direction. Furthermore, the fold-down link may be configured to fold down the previously pivoted and/or bent marginal section.

For example, the fold-down link may directly adjoin the aforementioned motion link and/or the aforementioned bending device by means of which the marginal section may be pivoted or bent by approximately 90 degrees, in particular at least 85 degrees and/or at least 90 degrees or exactly 90 degrees. The fold-down link may furthermore be formed in one part with the motion link and/or the bending device or as a unit separate therefrom.

For example, it may be provided that the fold-down link directly adjoins the bending device mentioned so that the marginal section may first be bent by approximately, in particular at least, 90 degrees by an interaction between the insertion device and the bending device and may then be completely folded down during the transport in the transport apparatus by means of the fold-down link. It may furthermore be provided that the fold-down link directly adjoins the motion link so that the marginal section may be continuously folded over during the transport by means of the transport apparatus and the subsequent movement by means of the packaging device.

The fold-down link may, for example, have a contact section that, starting from a vertical orientation along the transport direction of the packaging machine, increasingly approaches a horizontal orientation and/or increasingly tilts towards a transported portion support, wherein the contact section may be configured to contact the marginal section of a portion support and to increasingly fold it down as a result of the movement of the portion support along the transport direction. In embodiments with a motion link, it may therefore in particular be provided that the motion link and the fold-down link form a common, continuous folding link comprising a contact section that, starting from an at least approximately horizontal orientation, increasingly pivots towards a transported portion support in order to fold over the marginal section during the transport along the transport direction. In particular in such embodiments, the extent of the folding down of the marginal section during the transport at the transport apparatus and the extent of the folding down during the transport in the packaging machine may generally vary as desired so that, for example, a larger part of the folding down may take place during the transport at the transport apparatus or a larger part of the folding down may take place during the movement in the packaging machine.

In some embodiments, the packaging machine may have a hold-down device that is configured to counteract an unfolding of the inserted and folded portion support during the movement of the packaging spaces. Such a hold-down device may in particular have a boundary which is arranged above the packaging spaces and which the folded-down marginal section may contact during the transport in the packaging machine so that the portion support cannot unfold due to the counter-pressure exerted by the hold-down device. Such a boundary may, for example, be designed as a metal sheet or a belt and extend over the entire packaging machine or only a respective section of the packaging machine in which a marginal section of a portion support brought onto a packaging space is arranged.

Furthermore, in some embodiments, the aforementioned motion link may be configured to completely fold down the marginal section. For this purpose, after reaching a vertical orientation, the aforementioned contact section may, for example, increasingly pivot or tilt towards the portion support, viewed along the transport direction, to increasingly press the marginal section towards the placement section during the transport at the transport device and thereby to fold down said marginal section. In such embodiments, the portion support may thus be transferred to the packaging machine with the marginal section already completely folded down, wherein the packaging machine may, for example, have a hold-down device adjoining the motion link to prevent the portion support from unfolding.

In some embodiments, the packaging machine may have a portion support device that supports the inserted portions at a portion underside. In particular, in such embodiments, the packaging machine may further have the aforementioned hold-down device so that the marginal section may so-to-say be clamped between the portion support device and the hold-down device and an unfolding of the portion support may thereby be prevented.

In some embodiments, the provision device may be configured to provide the portion supports in an orientation in which the bending lines are oriented perpendicular to the transport direction of the packaging machine. In such embodiments, the system may furthermore comprise a turning device that is configured to rotate the portion supports, in particular with the placed portions, into an orientation in which the bending lines of the portion supports are aligned in parallel with the transport direction of the packaging machine.

As already explained, due to such a provision of the portion supports, it may in particular be made possible to feed the products to the cutting apparatus already along the transport direction and in an orientation in which the products lie on the product feed with a long side, in relation to a cross-sectional shape, and thus in a stable manner. Accordingly, after forming the portions, the cut-off slices may likewise be transported along the transport path in an orientation in which a long side of the slices is oriented perpendicular to the transport direction and may be moved in this orientation for the placing onto the portion supports so that the portions only have to be moved over a relatively short distance during the placing onto the portion support and may be positioned precisely on the portion supports.

However, since the system may further have a turning device in such embodiments, the portion supports may be automatically transferred to an orientation in which the bending lines are aligned in parallel with the transport direction of the packaging machine so that the portion supports may be brought onto the packaging spaces in such an orientation by means of the insertion device. In particular, this rotation of the portion supports may also take place without a manual intervention in the processing procedure and automatically by means of the turning device. The turning device may in particular be configured to rotate the portion supports individually with the respective placed portions so that, for example, portion supports with placed portions transported on multiple tracks may be separately rotatable in each track by means of the turning device. However, the turning device may also be configured to simultaneously rotate a plurality of portion supports.

In some embodiments, the insertion device may comprise the turning device and may be configured to rotate the portion support together with the placed portions during the insertion.

As already explained, the insertion device may, for example, have a robot gripper to bring the portions onto the packaging spaces. For example, such a robot gripper may be configured to grip the portion supports with the placed portions, to lift them and in particular to rotate them by 90 degrees in order to then bring the portion supports with the placed portions onto the packaging spaces in an orientation in which the bending line is aligned in parallel with the transport direction of the packaging machine. Furthermore, in some embodiments, it may be provided that the insertion takes place in two steps and the portion supports with the placed portions are, for example, first gripped by means of a robot gripper, rotated and then placed on a buffer device, whereupon the same or a further robot gripper may grip the portions placed on the buffer device again and remove them from the buffer device to bring the portions onto the packaging spaces. However, it may generally also be provided that the portion supports with the placed portions are taken over by the transport apparatus in a continuous movement and inserted into the packaging machine, wherein this continuous movement may comprise rotating the portions to align the bending lines of the portion supports in parallel with the transport direction of the packaging machine.

Alternatively or additionally, in some embodiments, the transport apparatus may comprise the turning device and may be configured to rotate the portion support together with the placed portions during transport.

For example, the transport apparatus may for this purpose comprise, in at least one section, a plurality of belts that extend in parallel along the transport direction and revolve continuously and that may be driven at different speeds to be able to exert a torque on a transported portion support with a placed portion and to be able to rotate the portion support with the placed portion. In particular, in such embodiments, a vacuum device may further be provided that is configured to suck in the portion supports with the placed portions in the region of the turning device in order to increase a friction between the portion supports and the belts and to support a controlled rotation of the portion supports. The configuration of the transport apparatus with a turning device may in particular be provided in embodiments that have a feeder for inserting the portions into the packaging machine so that the portion supports may be transferred beforehand into an orientation in which the bending lines are aligned in parallel with the transport direction. However, such a turning device may also be provided in embodiments in which the insertion device has a robot gripper for inserting the portions, wherein, in such embodiments, the portions may already be taken over by the robot gripper in an orientation in which the bending line is aligned in parallel with the transport direction of the packaging machine.

In some embodiments, the system may comprise a monitoring device, in particular a camera and an image evaluation device, that is configured to detect defective portions and incorrectly placed portions, in particular portions protruding beyond the portion support.

For example, a defective portion may be a portion comprising a slice from an end piece of the product that often has a shape that differs from a desired shape and therefore cannot be suitable for sale. Furthermore, a defective portion may, for example, for other reasons, for instance a fault in the cutting apparatus or an irregular product shape, comprise incorrectly shaped slices or also a faulty, e.g. torn, portion support. Portions that are too light or too heavy may, for example, also represent a defective portion, wherein the monitoring device may in particular comprise a scale to recognize such defective portions. A defective portion may generally be such a portion that is not suitable for sale and should therefore not be packaged.

Furthermore, in some embodiments, an evaluation and control device may be provided that is configured to flag a portion protruding beyond a portion support as a defective portion or as an incorrectly placed portion depending on a degree of the protrusion. The evaluation and control device may furthermore be configured to flag portions as defective portions that have already previously been recognized as defective portions. In particular, the evaluation and control device may comprise an image evaluation device to be able to evaluate recordings of the portions generated by a camera of the monitoring device and to recognize defective portions and/or incorrectly placed portions. The evaluation and control device may, for example, comprise one or more microprocessors and/or a CPU (Central Processing Unit).

For example, portions that protrude so far beyond a portion support that this incorrect positioning may neither be tolerated nor corrected during the insertion may be flagged as defective portions so that such portions cannot be packaged. On the other hand, portions that protrude only slightly beyond the portion support may first be flagged as incorrectly placed portions in order in particular to be able to correct or possibly even tolerate such misalignments and, ultimately, to nevertheless package the portions.

In some embodiments, the insertion device may be configured not to bring a defective portion onto a packaging space and/or to correct an orientation of an incorrectly placed portion during the insertion.

For example, the insertion device may have a robot gripper comprising respective contact elements to laterally grip the portion support and thereby to be able to push an incorrectly placed portion onto the portion support or its placement section. This may in particular be possible for those portions that protrude only slightly beyond the portion support and may therefore in particular have been previously marked as incorrectly placed portions by the evaluation and control device. The control of whether a portion is to be corrected or whether a portion is not to be inserted may in particular take place by the aforementioned evaluation and control device.

Since the system has a monitoring device for recognizing defective portions and/or incorrectly placed portions and the insertion device may be configured to correct an orientation of an incorrectly placed portion during the insertion and/or not to bring defective portions onto a packaging space, the inspection of portions, the sorting out of defective portions and/or the correction of incorrectly placed portions may also take place automatically. However, in conventional systems, it is usually necessary to check, correct or sort out the portions manually or by appropriate personnel in that the portions may, for example, be checked in the course of the manual folding over of the marginal section of a portion support, for which purpose a corresponding additional time expenditure must be allowed, however. The configuration with a monitoring device may thus further increase the degree of automation of the system and the speed of processing.

Furthermore, since defective portions and in particular portions comprising first-cut slices or end slices may be reliably and automatically sorted out, the cutting process may be continuously performed since, for example, such first-cut or end slices do not already have to be sorted out at the cutting apparatus. Interruptions to the cutting process that are associated with the removal of first-cut or end slices may therefore be avoided to be able to achieve an as high as possible product throughput.

In some embodiments, the packaging machine may be configured to manufacture reclosable packages. In particular, the packaging machine may be configured to form packages having a reclosure so that the portions may, for example, be removed multiple times from the package by a customer and reinserted into the package, wherein the shelf life of the portions may be increased by reclosing the package.

In such embodiments, the packaging machine may furthermore have a device for attaching a reclosure element that is configured to attach the reclosure element along the transport direction to a marginal section of a package. In particular, the device for attaching a reclosure element may be configured to attach the reclosure element to a marginal section of a packaging depression or another packaging space along the transport direction.

Since the reclosure element may be attached along the transport direction of the packaging machine, the reclosure element may also be attached in parallel with the bending line of the portion support and in this regard along a long side of the portion support and/or the package. This makes it possible to open the package along the long side and to close it again so that the removal and reinsertion of a portion may be made as easy as possible. Furthermore, the movement of the packaging spaces along the transport direction may be directly used to attach the reclosure element, for example, in that a self-adhesive tape as the reclosure element may be brought into contact with a material web provided by the packaging machine and may be automatically pulled off a roll due to the movement of the material web along the transport direction.

In some embodiments, the reclosure element may be configured as a self-adhesive tape or as a zipper closure. To close the package, a zipper closure may in particular be able to be pushed in or have a movable element for closing and opening the zipper closure. In particular during a deep-drawing at a deep-draw packaging machine, a self-adhesive tape may be attached to a marginal section of a packaging depression so that a subsequently fed upper material web and/or upper film for sealing the package may be glued to the self-adhesive tape and the package may be opened and reclosed at the adhesive point.

In some embodiments, the packaging machine may be configured to simultaneously provide at least two packaging spaces that are offset from one another perpendicular to the transport direction and to move them along the transport direction. The packaging machine may furthermore have a perforating device that is configured to produce a perforation along the transport direction between two packaging spaces disposed next to one another. For example, with such an alignment of the perforation in the transport direction, known possibilities for producing a perforation using a rolling blade in the discharge region of a packaging machine, in particular in the region of a longitudinal cut required at the package margins, may be used.

The packaging machine may in this regard be configured to be operated with at least two tracks so that two packaging spaces may be moved next to one another and, ultimately, two packages disposed next to one another with inserted portions may be produced. Since the packaging machine, however, has a perforating device, the two packages manufactured in parallel may, for example, be sold together as a food package arrangement, wherein a customer or consumer may, however, selectively separate the packages along the perforation in a simple manner. For example, such a perforation may be formed by a perforation blade that revolves in a plane aligned in parallel with the transport direction and that may in particular be arranged after or downstream of a sealing station for sealing the packages.

In some embodiments, the packaging machine may have three tracks and may be configured to simultaneously provide three packaging spaces that are offset from one another perpendicular to the transport direction and to move them along the transport direction. Furthermore, in some embodiments, the packaging machine may be configured to move the packaging spaces in cycles and the packaging spaces may be filled during a cycle.

As already explained, such a three-track design of the packaging machine is in particular made possible in that the system has an insertion device that is configured to bring the product supports onto the packaging spaces such that the bending line is aligned in parallel with the transport direction so that the extent of the inserted portion supports perpendicular to the transport direction may be minimized and the required width of the packaging machine may thereby be reduced. This in particular also makes it possible to use the system to manufacture food package arrangements that comprise three food packages with respective packaged portions, said food packages being disposed next to one another and connected to one another. However, such food arrangements cannot be produced with conventional systems, in which the portion supports must be packaged with marginal sections oriented perpendicular to the transport direction of the packaging machine, since a correspondingly wide packaging machine cannot be realized.

In some embodiments, the packaging machine may be configured for a cyclical operation and may be configured to provide a format of nine packaging spaces, twelve packaging spaces or sixteen packaging spaces in each cycle, wherein the packaging spaces of the format are arranged in three columns and three rows or in three columns and four rows or in four columns and three rows or in four columns and four rows. The insertion device may further be configured to bring nine portions, twelve portions or sixteen portions onto the respective provided packaging spaces during a cycle.

For example, the insertion device may comprise two robot grippers that may alternately insert five or four portions into the packaging machine in a respective cycle to be able to fill a format of packaging spaces provided in three columns and three rows. Furthermore, the operation of a feeder and the packaging machine may be coordinated such that a respective format of portions may be brought onto the provided packaging spaces during a feed of the packaging machine or during the standstill of the packaging machine.

In some embodiments, the packaging machine may furthermore have a separating device that may be configured to separate the rows and/or columns of a format from one another. For example, such a separating device may have a blade that may be moved in a plane oriented perpendicular to the transport direction to be able to separate the fed packaging spaces from one another row-wise and to produce a food arrangement that comprises a number of mutually connected individual food packages corresponding to the number of columns of a format. Alternatively or additionally, it may also be provided that the separating device has one or more blades revolving in parallel with the transport direction to also be able to separate the completed packages column-wise and in particular to manufacture individual food packages.

The invention further relates to a method for manufacturing a food package or a food package arrangement, in particular by means of a system according the present disclosure, in which
slices are cut off from a food product, in particular a meat product and/or a piece of bacon, and portions are formed that comprise one or more slices;
the portions are transported along a transport path and are placed on a placement section of a respective provided portion support during transport such that a marginal section of the portion support protrudes beyond the placed portion and is not covered by the portion;
the portion support is folded along a bending line, wherein the marginal section is folded over onto a portion upper side by the folding; and
the portions together with the respective portion supports are brought onto packaging spaces provided by a packaging machine such that the bending lines of the inserted portion supports are aligned in parallel with a transport direction along which the packaging machine moves the packaging spaces.

As already explained, such a method, which may in particular take place in a fully automated manner, in particular makes it possible to operate the packaging machine with multiple tracks and/or three tracks to thereby increase the product throughput and the flexibility with regard to the production of food package arrangements that comprise a plurality of mutually connected individual food packages.

In some embodiments, the portion supports may be provided in an orientation in which the bending line is oriented perpendicular to the transport direction of the packaging machine and the portion supports may be rotated after the provision such that the bending lines are aligned in parallel with the transport direction. In this regard, the portion supports may first be provided in an orientation that reflects an orientation of the portions after the cutting off of the slices by means of the cutting apparatus. The portions may thereby be moved along a short side in particular during the placing on the portion supports in order thereupon to be rotated together with the portion supports so that a long side of the portions and the portion supports along which the bending line also extends is aligned in parallel with the transport direction and the space occupied by the portion support and a placed portion perpendicular to the transport direction may be minimized.

In some embodiments, the portion support may be folded during the insertion and/or during the transport. In particular, this folding may take place automatically so that no manual intervention in the processing of the food products, in particular during the aforementioned method steps, has to take place.

Furthermore, in some embodiments, a reclosure element extending along the transport direction may be attached to the food package. In this regard, the food packages may in particular be configured as reclosable. For example, a self-adhesive tape extending along the transport direction or a zipper may be attached to the food package to enable a reclosing of the food package after an opening by the customer.

In some embodiments, a row of three packaging spaces that are offset from one another perpendicular to the transport direction and that are connected to one another may be provided simultaneously and/or in a cycle by the packaging machine and a respective portion placed on an associated portion support may be brought onto each of the packaging spaces of the row. The three portions may in particular be inserted into the packaging machine in a cycle of the packaging machine, wherein the packaging machine may in particular be configured to provide a format of packaging spaces consisting of three rows and three columns in a cycle. This may in particular make it possible to produce a food package arrangement comprising three individual food packages that are offset from one another perpendicular to the transport direction and connected to one another in that the packaging spaces may be separated from one another row-wise in a subsequent step, in particular after sealing the packages. In particular, a row of exactly three packaging spaces that are offset from one another perpendicular to the transport direction and connected to one another may be provided simultaneously and/or in a cycle by the packaging machine.

In some embodiments, a perforation extending along the transport direction may be formed between the packaging spaces of the row. This may in particular be provided in the manufacture of food package arrangements in which the three individual food packages of a row remain connected to one another and are sold in such a way to enable a customer to easily separate the individual food packages from one another along the perforation.

Furthermore, in some embodiments, two packaging spaces that are offset from one another perpendicular to the transport direction and connected to one another may be provided simultaneously and/or in a cycle by the packaging machine and a respective portion placed on an associated portion support may be brought onto each of the packaging spaces, wherein a perforation extending along the transport direction may moreover be formed between the packaging spaces disposed next to one another.

In some embodiments, consecutive rows may be separated from one another after the insertion of the portions and the rows may be output as respective food package arrangements comprising three mutually connected food packages. The consecutive rows may in particular be separated after the sealing of the packaging spaces. In this respect, a provision of such food package arrangements comprising three mutually connected food packages may in particular be made possible by inserting the portion supports such that the bending line is aligned in parallel with the transport direction of the packaging machine, whereas the conventional orientation of the bending line perpendicular to the transport direction of the packaging machine requires a width in relation to a transverse direction of such a food package arrangement oriented perpendicular to the transport direction, which width cannot be provided in view of the available space for such systems and/or the design possibilities of packaging machines.

In some embodiments, consecutively fed products may be continuously sliced and portions may be sorted out that comprise slices of an end piece of a product and/or a first-cut slice. In particular, an interruption of the cutting process to eject first-cut slices or end slices of a product may thus be avoided and portions may be continuously formed in order, however, to sort out portions comprising such first-cut or end slices as defective portions. The process control may thereby in particular be simplified overall and the product throughput may be increased. This may in particular be provided if the system, as explained above, has a monitoring device so that such defective portions may be automatically recognized.

In some embodiments, a misalignment of portions placed on a respective portion support may be corrected. As already explained, this may, for example, take place by a robot gripper of an insertion device during the insertion of the portions into the packaging machine.

Furthermore, in some embodiments, the packaging spaces, in particular packaging depressions and/or trays and/or defined spaces on a material web, may be closed to manufacture completed food packages.

Provision may also be made to separate packaging spaces and/or packages disposed next to one another from one another to ultimately manufacture individual food packages.

Said method steps may be automatically performed in some embodiments. In particular, said method steps may thus be performed without manual intervention so that the system has a high degree of automation and a high product throughput may be achieved. In particular, in such embodiments, it is no longer necessary to manually fold down the marginal section, to manually insert the portion supports with placed portions into the packaging machine and/or to check the portions by a person operating the system.

The invention further relates to a food package in which a portion is packaged that is arranged on a portion support and that comprises one or more slices of a food product, in particular a meat product and/or a piece of bacon, wherein the portion support is folded along a bending line and has a folded-over marginal section that at least sectionally covers a portion upper side of the portion, and wherein a portion underside facing away from the portion upper side lies on a placement section of the portion supports. The food package furthermore has a long side extending along a longitudinal direction and a short side extending along a transverse direction and may in particular be substantially rectangular. Furthermore, the bending line of the portion support extends parallel to the longitudinal direction. The food package may in particular be manufactured by a method of the above-explained kind.

The portion support of such a food package may be planar and/or substantially rectangular, in particular in the not folded-over state, wherein the portion support may, however, in particular also be substantially square in the not folded-over state. At least after the folding down of the marginal section, the portion support may, however, have a long side and a short side and/or the placement section may be substantially rectangular, wherein the bending line may extend along the long side of the portion support and/or of the placement section. Since the bending line in the food package is furthermore oriented along the longitudinal direction of the food package along which the long side of the food package also extends, the portion support with the placed portion may be arranged in the food package in an orientation corresponding to the food package.

In some embodiments, the food package may have a reclosure that extends parallel to the bending line of the portion support. The reclosure may in particular comprise a zipper or a self-adhesive tape to be able to reclose the food package after an opening. Since the reclosure may also extend parallel to the bending line, the reclosure in particular extends along the longitudinal direction of the food package, and thus along the long side of the food package, to make a removal of the portion from the food package and a reinsertion of the portion into the food package as easy as possible for a customer.

The invention further relates to a food package arrangement that comprises three mutually connected food packages of the above-explained kind, wherein the transverse directions of the food packages are aligned in parallel with one another and the food packages are arranged next to one another in the transverse direction. The food package arrangement may in particular also be manufactured in accordance with a method of the above-explained kind.

The food package arrangement may in particular comprise exactly three food packages. However, it is also possible for the food package arrangement to comprise four mutually connected food packages. For example, the food packages of the food package arrangement may be formed by a row of a format of packaging spaces which the packaging machine provides during a cycle.

In some embodiments, a perforation extending along the longitudinal direction may be provided between two food packages disposed next to one another. On the one hand, this may enable a package formation with, for example, two or three food packages for sale, wherein a buyer or consumer of the food package arrangement may, on the other hand, be offered a possibility of selectively isolating the food packages purchased in the package and/or separating them from one another.

Furthermore, in some embodiments, each of the food packages may have a respective reclosure that extends parallel to the bending line of the packaged portion support. In particular in embodiments in which the food package arrangement additionally has a perforation between the individual food packages, the food packages may thus be conveniently separated from one another and the portion arranged in a respective food package may be consumed, wherein the portion may, if necessary, be removed from the food package multiple times and reinserted into the food package, whereupon the food package may be reclosed. In this regard, it may be made possible to offer a large portion with three mutually connected food packages, wherein the buyer or consumer may conveniently divide such a large portion into individually packaged portions and consume them in this way. Furthermore, such food package arrangements may enable discount campaigns such as “buy three, pay two”.

### BRIEF DESCRIPTION OF THE DRAWINGS

The invention will be explained in the following purely by way of example with reference to embodiment examples and to the drawing.

There are shown:

FIGS. 1A and 1B a side view or a plan view of a schematic representation of a system for processing food products comprising a cutting apparatus for slicing food products, a packaging machine for packaging the food products, a transport apparatus for transporting the portions to the packaging machine, a provision device for providing portion supports on which the portions are placed during the transport to the packaging machine, and an insertion device for inserting the portion supports with the placed portions into the packaging machine;

FIG. 2 a representation of a robot gripper of the insertion device;

FIGS. 3A to 3C respective schematic representations for illustrating the insertion of a portion support with a placed portion into the packaging machine;

FIGS. 4A to 4G respective schematic representations for illustrating an interaction between the insertion device and a bending device that is arranged at the packaging machine and that is configured to fold down a marginal section of a portion support by approximately, in particular at least, 90° during the insertion, and for illustrating a fold-down link that is arranged at the packaging machine and that is configured to fold down the marginal section during a movement of the portion support with the placed portion in the packaging machine;

FIG. 5 a schematic plan view for illustrating a further embodiment of the system;

FIGS. 6A to 6D respective schematic representations for illustrating a motion link and a fold-down link for folding down the marginal section of the portion support;

FIG. 7 a further schematic plan view for illustrating a format of packaging spaces provided by the packaging machine;

FIG. 8 a schematic representation of a food package arrangement comprising three mutually connected food packages that may be manufactured by means of the system shown; and

FIG. 9 a representation of a portion support.

### DETAILED DESCRIPTION

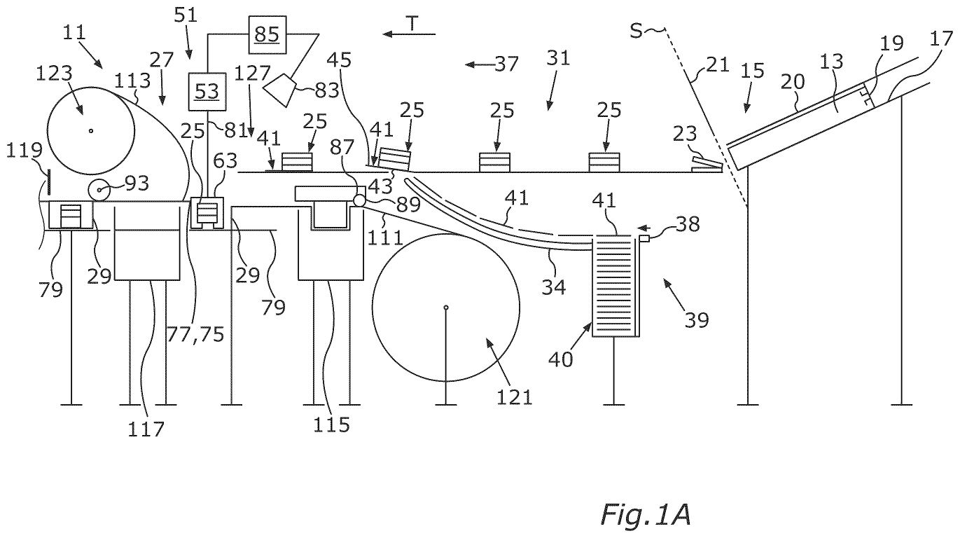

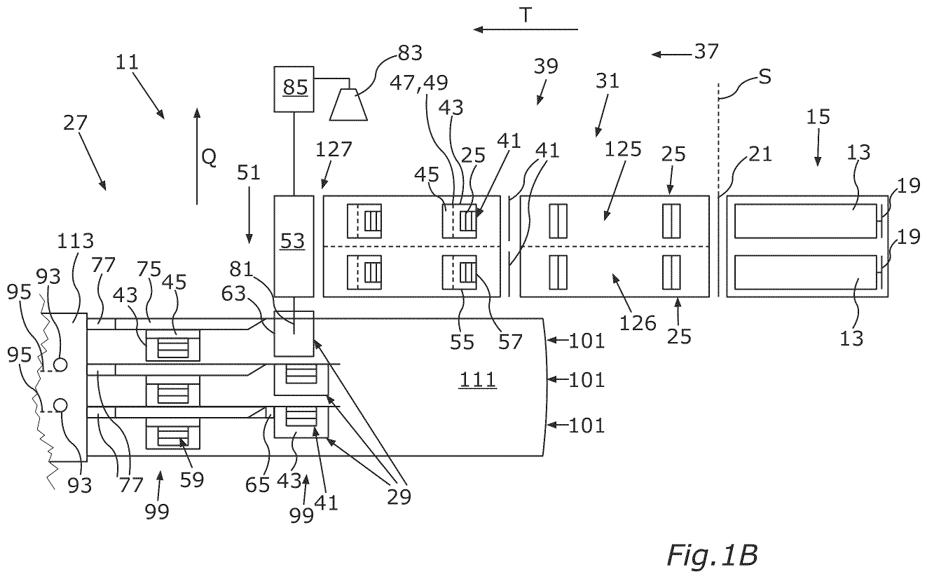

FIG. 1A shows a system 11 for processing food products 13 that are fed from a product feed 17 of a cutting apparatus 15 to a blade 21 that revolves in a cutting plane S and that cuts off slices 23 from the food products 13. The product feed 17 in this respect has a gripper 19 that is moveable in a guide 20 and that holds the food product 13 guided into the cutting plane S at a rear product end and moves it towards the cutting plane S. As FIG. 1B shows, the cutting apparatus 15 is configured to cut off slices 23 from two food products 13 fed in parallel so that the food products 13 may be processed in two tracks 125.

The cutting apparatus 15 is further configured to form a portion 25 from the cut-off slices 23, wherein a portion 25 may in particular comprise one or more slices 23. Completed portions 25 are transferred from the cutting apparatus 15 to a transport apparatus 31 that is configured to transport the portions 25 along a transport path 37, which extends along a transport direction T, to a packaging machine 27, wherein the portions 25 are brought onto packaging spaces 29 provided by the packaging machine 27 by means of an insertion device 53.

In the embodiment in particular illustrated by means of FIG. 1A, the packaging machine 27 is configured by way of example as a deep-draw packaging machine in which a material web 111 is drawn off a roll 121 and is first fed to a molding station 115 that makes depressions in the material web 111 to form the packaging spaces 29. Furthermore, a device 87 for attaching a reclosure element 89, for example a self-adhesive tape, is arranged at the molding station 115, wherein the reclosure element 89 may, for example, be drawn off a roll due to the movement of the material web 111.

The packaging machine 27 is configured to move the material web 111 along the transport direction T so that the formed packaging spaces 29 may be moved to an insertion section 127 at which portions 25 provided by means of the transport apparatus 31 are inserted into the packaging spaces 29 or depressions by the insertion device 53. In the embodiment example shown by FIGS. 1A and 1B, the insertion device 53 has a robot gripper 63, described in more detail below, for this purpose.

As FIG. 1B shows, the packaging machine 27 is in particular configured to simultaneously provide three packaging spaces 29 disposed next to one another with respect to a transverse direction Q, which is oriented perpendicular to the transport direction T of the packaging machine 27, so that the packaging machine 27 may so-to-say be operated with three tracks. Furthermore, the packaging machine 27 may in particular be operated in cycles, wherein at least one row 99 of packaging spaces 29 arranged in three columns 101 may be provided during a cycle. The insertion device 53 may furthermore be configured to bring a respective portion 25 onto each of the simultaneously provided packaging spaces 29 during a cycle.

By moving the material web 111 along the transport direction T, the filled packaging spaces 29 may further be fed to a sealing station 117 in which the packaging spaces 29 may be sealed by an upper material web 113 that may be drawn off a roll 123 (cf. FIG. 1A). Downstream of the sealing station 117, a perforating device 93 is then arranged that may, for example, have one or more blades revolving in a plane aligned in parallel with the transport direction T to be able to form a perforation 95 between two packages disposed next to one another (cf. also FIG. 1B).

The system 11 furthermore has a provision device 39 that is configured to provide portion supports 41 for the transported portions 25 such that the portions 25 transported by the transport apparatus 31 may be placed on a placement section 43 of a respective portion support 41 (cf. in particular FIGS. 1A and 1B). For this purpose, the provision device 39 comprises a stack 40 of portion supports 41 that are removed from the stack 40 by means of a removal device 38 and guided to the transport path 37 via a feed 34, in particular a band conveyor, so that a portion 25 may be placed on a placement section 43 of a provided portion support 41.

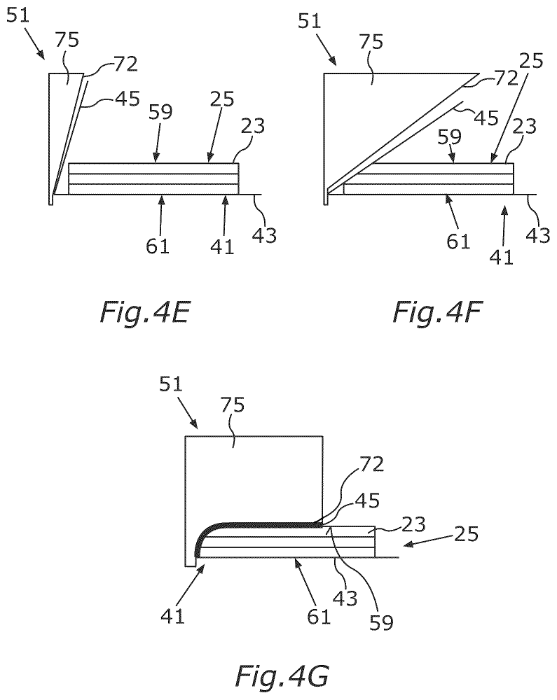

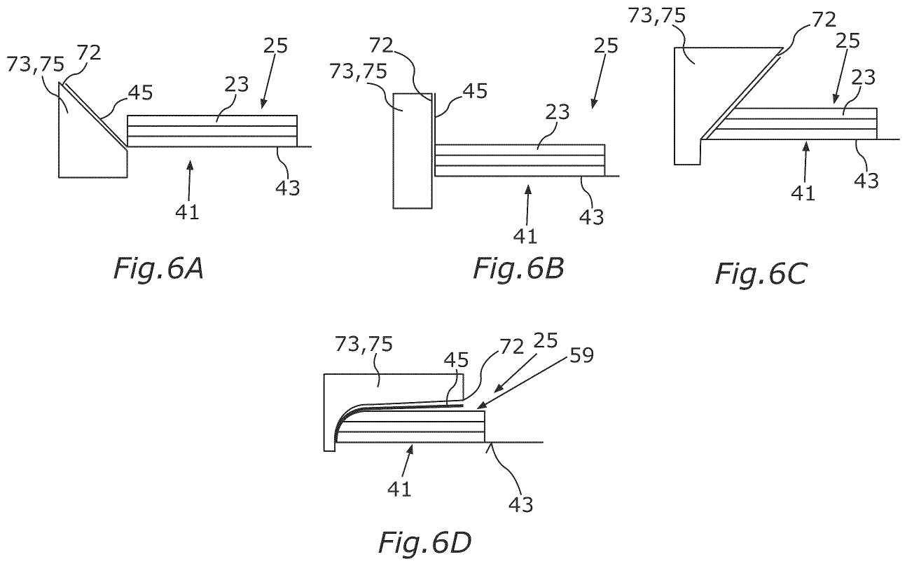

While the placed portions 25 contact the placement section 43 with a portion underside 61 (cf., for example, also FIGS. 4D to 4G), the portion supports 41 further have a marginal section 45 that is not covered by the placed portions 25. As will be explained below, such a marginal section 45 may in particular be provided to be folded down during the processing of the food products 13 such that the marginal section 45 at least partly covers a portion upper side 59 of a placed portion 25 (cf., for example, FIGS. 4G and 6D).

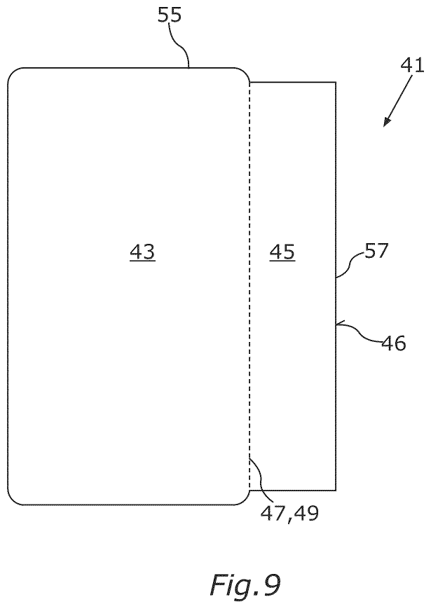

An exemplary portion support 41, which may be provided by means of the provision device 39, is illustrated in FIG. 9. In the not folded-over state of the marginal section 45, the portion support 41 is planar. Furthermore, the portion support 41 has a long side 57 and a short side 55 and is substantially rectangular, wherein the marginal section 45, however, has a slightly shorter extent along the long side 57 than the placement section 43. Furthermore, the placement section 43 takes up a larger proportion of the surface of the portion support 41 and has a greater extent along the short side 55 or a greater width than the marginal section 45. Furthermore, the placement section 43 is in particular also substantially rectangular and is formed with a long side 57 and a short side 55.

A transition between the marginal section 45 and the placement section 43 furthermore defines a bending line 49 along which the marginal section 45 may be folded down. As an example, the bending line 49 is formed as a fold 47 that may in particular comprise a perforation so that the bending line 49 is also recognizable in the not folded-over state of the marginal section 45. However, it is also possible that the portion support 41 is formed uniformly and/or with a constant thickness and that the bending line 49 is defined by a defined spacing from a margin 46 of the portion support 41 facing away from the placement section 43.

The portion support 41 may further, for example, also be completely rectangular, possibly with rounded corners, or square. As already mentioned, such portion supports 41 may be provided to be arranged engaging around a portion 25 by folding down the marginal section 45 and arranging it to cover a portion upper side 59 of a portion 25. Due to the intended folding down of the marginal section 45, such portion supports 41 may in particular also be called L-boards in view of the shape when the marginal section 45 is being folded down. Folding down the marginal section 45 may, for example, enable product information and/or advertising elements to be displayed on the marginal section 45 so that a buyer of a packaged portion 25 may perceive both an uncovered part of the portion upper side 59 and such product information. Furthermore, the engagement around of the portions 25 may make it possible to remove the portion 25 from a packaging without having to directly contact the portion 25 itself or individual slices 23.

FIG. 1B further shows that the provision device 39 is configured to provide the portion supports 41 in an orientation in which the bending line 49 is oriented perpendicular to the transport direction T of the packaging machine 27. In this regard, the portion supports 41 may be provided such that the long side 57 is oriented perpendicular to the transport direction T. This may in particular make it possible to move the portions 25, which likewise have a long and a short side due to the usual cross-sectional shape of the food products 13 and which may be moved with the long side at the front due to the feeding of the food products 13 lying on the long side, over the short side onto the portion supports 41 and to place them precisely.

However, such a provision of the portion supports 41 requires a relatively wide design of the transport apparatus 31 or a relatively large extent of the transport apparatus 31 in the transverse direction Q since the latter must correspond to at least twice the extent of the portion supports 41 along their long sides 57. In conventional systems, in which the portion supports 41 with the placed portions 25 must also be transferred to the packaging machine 27 in this orientation, it is therefore not possible, unlike in the system 11 disclosed herein, to package three portion supports 41 with respective placed portions 25 next to one another in the transverse direction Q since a correspondingly wide design of the packaging machine 27 in the transverse direction Q cannot be realized.

However, to be able to provide three packaging spaces 29 next to one another and to operate the packaging machine 27 with three tracks, the insertion device 53 of the system 11 is configured to bring the portion supports 41 with the respective placed portions 25 onto the provided packaging spaces 29 such that the bending lines 49 of the inserted portion supports 41 are aligned in parallel with the transport direction T of the packaging machine 27. In the embodiments illustrated by means of FIGS. 1A and 1B, the insertion device 53 has a turning device 81 for this purpose that is configured to rotate the portion supports 41 with the placed portions 25 by 90° during the insertion into the packaging machine 27 and, as a result, to achieve an alignment of the bending line 49 in parallel with the transport direction T.

Furthermore, it is provided to fold down the marginal section 45 so that the marginal section 45, as already explained, may at least partly cover the portion upper side 59 of the associated and packaged portion 25. To also be able to perform this folding down, the system 11 has a folding device 51, whereas the folding down of the marginal section 45 usually has to take place manually in conventional systems. In the embodiment illustrated by FIGS. 1A and 1B, the folding device 51 comprises a bending device 65 that is arranged at the packaging machine 27 and that is configured to bend the marginal section 45 of an inserted portion support 41 by approximately, in particular at least, 90° by interacting with the insertion device 53. Furthermore, a fold-down link 75 is arranged at the packaging machine 27 to completely fold down the marginal section 45 during the movement of the portion support 41 in the packaging machine 27. This will be explained in more detail below.

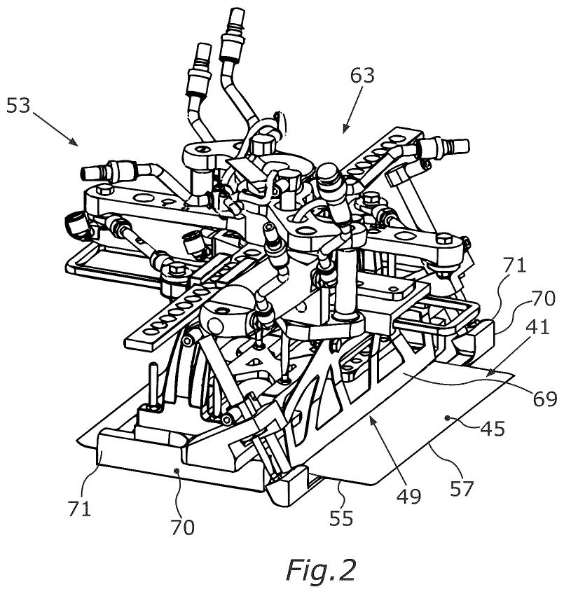

FIG. 2 first shows the robot gripper 63 of the insertion device 53. The robot gripper 63 in particular has two gripper elements 70 comprising respective contact sections 71 that are configured to contact and grip beneath a provided portion support 41 at oppositely disposed short sides 55 to be able to lift the portion support 41 with the placed portion 25. This may in particular also make it possible to push a portion 25 possibly protruding slightly beyond the portion support 41 completely onto the placement section 43 of the portion support 41. Furthermore, the robot gripper 63 comprises a holding edge 69 that fixes the bending line 49 during an insertion of a portion support 41 and the placed portion 25.

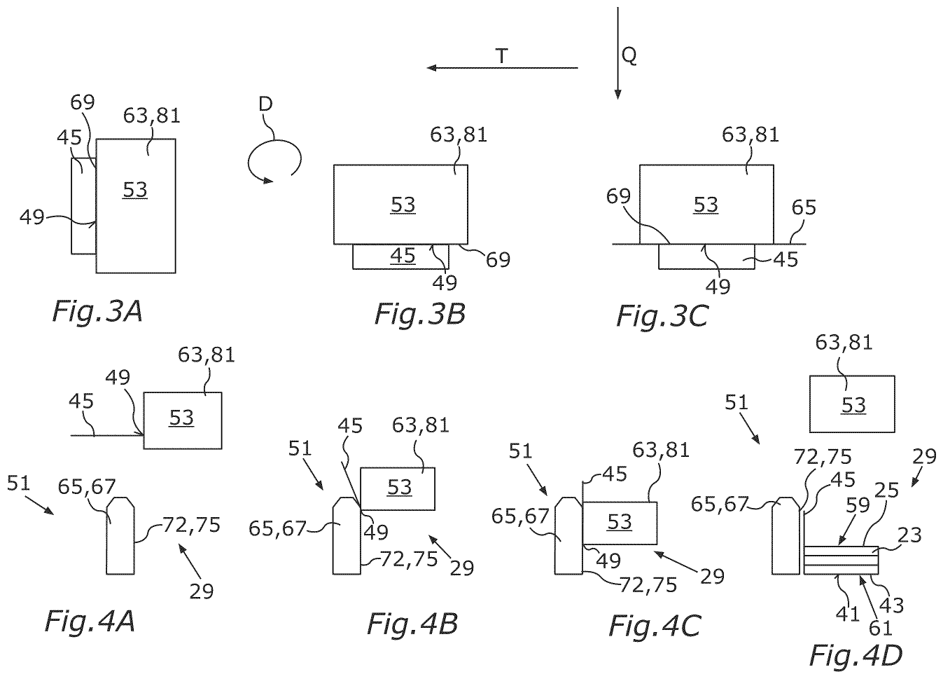

FIGS. 3A to 3C first illustrate steps performed by the insertion device 53 by means of the robot gripper 63 before the portion support 41 with the placed portion 25 is lowered into a packaging space 29, wherein schematic plan views are shown. FIGS. 4A to 4D then show schematic side views during the subsequent insertion into a packaging space 29 and FIGS. 4E to 4G show schematic cross-sectional representations in a plane perpendicular to the transport direction T during a movement of the inserted portion support 41 with the placed portion 25 in the packaging machine 27.

As FIG. 3A shows, a portion support 41 with a placed portion 25 may first be gripped by means of the robot gripper 63, for which purpose in particular the portion support 41 may be gripped beneath by means of the gripper elements 70 (cf. also FIG. 2). The holding edge 69 may in this respect be arranged along the bending line 49.

The portion support 41 may then be lifted by the transport apparatus 31 and the robot gripper 63 may perform a rotation D to align the bending line 49 in parallel with the transport direction T (cf. FIG. 3B). Furthermore, as FIG. 3C shows, the robot gripper 63 may be moved such that the bending line 49 is arranged above the bending device 65 that may in particular comprise a web 67. This position is also illustrated in the schematic side view of FIG. 4A in which the robot gripper 63 is shown schematically above a packaging space 29 and the marginal section 45 of the portion support 41 is arranged above the bending device 65 and the web 67.

FIGS. 4B and 4C show that the robot gripper 63 may then lower the portion support 41 with the placed portion 25 onto the packaging space 29, wherein the marginal section 45 comes into contact with the bending device 67 and is bent by 90° during the lowering. The holding edge 69 of the robot gripper 63 in this respect compensates a force acting on the marginal section 45 at the bending line 49 so that the marginal section 45 may be bent exactly at the bending line 49.

As FIG. 4D illustrates, the robot gripper 63 may be lifted after the portion support 41 with the portion 25 placed thereon has been placed on the packaging space 29, wherein the marginal section 45 is bent by approximately 90 degrees due to the previous interaction between the robot gripper 63 and the bending device 49.

FIGS. 4D to 4G then illustrate the transport of the portion support 41 with the placed portion 25 along the transport direction T in the packaging machine 27. To completely fold down the marginal section 45, the folding device 51 comprises the aforementioned fold-down link 75 that is arranged at the packaging machine 27. The fold-down link 75 has a contact section 72 that is configured and arranged to contact the marginal section 45, wherein the marginal section 45 may already contact the contact section 72 after the insertion into the packaging space 29 and the fold-down link 75 may directly adjoin the bending device 49.

As FIGS. 4D to 4G show, the contact section 72 increasingly tilts with respect to the vertical, viewed along the transport direction T, so that the marginal section 45 increasingly folds down during the transport along the transport direction T due to the contact with the contact section 72 until the marginal section 45, as FIG. 4G shows, is finally completely folded down and at least partly covers the portion upper side 59 of the portion 25. The bending device 49 and the fold-down link 75 thus make it possible, by interacting with the insertion device 53 and by utilizing the movement of the packaging machine 27, to completely automatically fold down the marginal section 45, starting from a portion support 41 provided as planar, without manual intervention in the processing procedure being required for this folding down.

As again in particular FIG. 1B shows, a hold-down device 77 that is configured to counteract an unfolding of the portion support 41 may furthermore adjoin the fold-down link 75. The hold-down device 77 may in particular comprise a boundary arranged in a horizontal orientation, for example a metal sheet, to prevent an unfolding of the folded-over marginal section 45. Furthermore, as FIG. 1A shows, a portion support device 79 is provided at the packaging machine 27 and supports portions 25 inserted into the packaging spaces 29 so that the folded-over marginal section 45 may so-to-say be clamped between the hold-down device 77 and the portion support device 79.

Furthermore, the system 11 illustrated by means of FIGS. 1A and 1B has a monitoring device 83 that is configured to detect defective portions and/or portions 25 placed incorrectly on a portion support 41. For example, the monitoring device 83 may for this purpose have a camera and an evaluation and control device 85, which is connected to the monitoring device 83 and/or is part of the monitoring device 83, may comprise an image evaluation device to be able to recognize defective portions and/or incorrectly placed portions 25. The evaluation and control device 85 may then be configured to control the insertion device 53 and in particular the robot gripper 63 not to transfer defective portions to the packaging machine 27 and/or to correct an orientation of incorrectly placed portions 25, for which purpose in particular protruding portions 25 may be pushed onto the portion support 41 by means of the contact sections 71 of the robot gripper 63. However, the evaluation and control device 85 may also be configured to mark portions 25 protruding beyond the portion support 41 either as a defective portion or as an incorrectly placed portion 25 depending on a degree of the protrusion so that portions 25 whose orientation may no longer be corrected cannot be transferred from the insertion device 53 to the packaging machine 27 either. Furthermore, portions 25 that have misshapen first-cut slices or slices 23 from an end piece of a food product 13 may, for example, be marked as defective portions and sorted out. Furthermore, the monitoring device 83 may also comprise a scale, not shown, in order, for example, to be able to mark and/or sort out underweight and/or overweight portions 25 as defective portions.

The system 11 may thus in particular enable a fully automatic operation in which in particular the conventionally manually performed folding of the marginal section 45 and/or the checking of portions 25 may take place automatically by means of the folding device 51 or the monitoring device 83. Since the insertion device 53 is furthermore configured to insert the portion supports 41 into the packaging machine 27 such that the bending line 49 is formed parallel to the transport direction T, it is also possible to insert a plurality of and in particular three portion supports 41 with placed portions 25 in the transverse direction Q next to one another into the packaging machine 27 and to package them, which cannot be achieved with conventional systems.

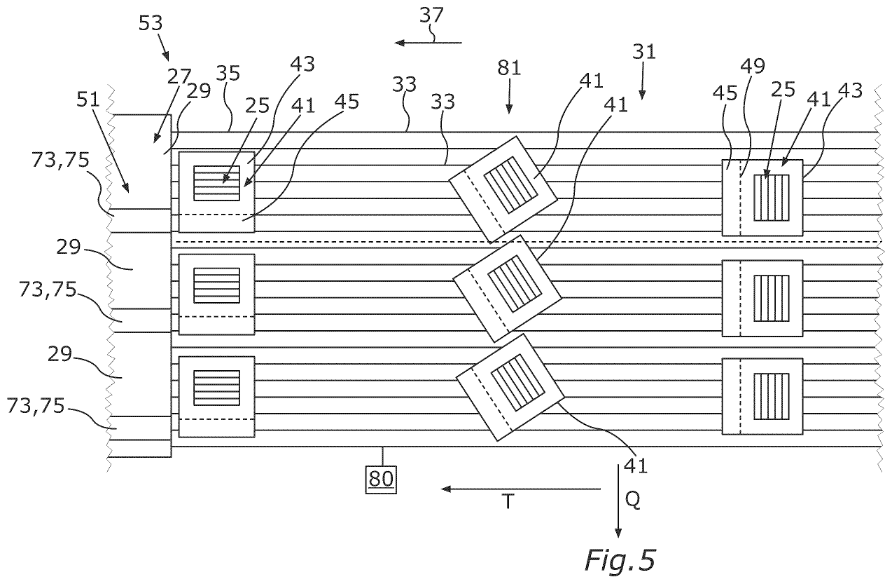

A further embodiment of the system 11 is illustrated by means of FIG. 5. In this embodiment, the transport apparatus 31 already comprises a turning device 81 so that the portion supports 41 may be rotated along the transport path 37 during transport and the bending lines 49 of the portion supports 41 may be brought into an orientation in which the bending lines 49 extend parallel to the transport direction T.

To be able to rotate the portion supports 41 during the transport along the transport path 37, the transport apparatus 31 or the turning device 81 comprises a plurality of continuously revolving belts 33 extending along the transport direction T that are driven at different speeds. This driving of the belts 33 at different speeds results in a torque being exerted on the portion supports 41 by which the portion supports 41 are rotated. To be able to ensure a sufficient friction of the portion supports 41 at the belts 33 and a reliable rotation, a vacuum device 80 may further be provided that is configured to suck in the portion supports 41 towards the belts 33.

Furthermore, in this embodiment, the transport apparatus 31 comprises a transport device 35 that faces the packaging machine 27 and that is configured to transfer the portion supports 41 with the placed portions 25 to the packaging machine 27 and to bring them onto packaging spaces 29 so that the transport device 35 is also part of the insertion device 53. Such a transport device 35 may in particular be a feeder that, as an alternative to the design shown with a plurality of parallel belts 33 driven at the same speed, may in particular also be configured as a continuous transport band.

To also be able to automatically fold down the marginal section 45 of a portion support 41 in such an embodiment, the folding device 51 has a motion link 73 and a fold-down link 75, wherein they are shown by way of example in FIG. 5 as part of the packaging machine 27. However, it may in particular be provided that the motion link 73 explained below is already arranged at the transport path 37 so that the portion supports 41 may in particular be transferred to the packaging machine 27 again with the marginal section 45 bent by approximately 90 degrees. Furthermore, it is possible that the fold-down link 75 adjoining the motion link 73 is also already arranged at the transport device 35 so that the portion supports 41 may be transferred to the packaging machine 27 already completely folded in some embodiments.

As FIGS. 6A and 6B show, a contact section 72 of the motion link 73 and of the fold-down link 75 may first tilt along the transport direction T increasingly towards a vertical orientation with respect to the horizontal so that the marginal section 45 of a portion support 41 may run onto the contact section 72 during the transport in the transport direction T and may initially be bent by approximately 90 degrees by said contact section 72 during transport (cf. FIG. 6B). After reaching a folding by 90 degrees, the contact section 72 may, as shown in FIGS. 6C and 6D, in turn increasingly tilt or pivot towards the horizontal and towards the portion support 41, viewed along the transport direction T, so that the marginal section 45 may ultimately be completely folded down during the transport along the transport direction T and may be arranged above the portion upper side 59. Even in such embodiments, inserting the portion supports 41 with bending lines 49 oriented along the transport direction T into the packaging machine 27 and folding down the respective marginal section 45 may thus be achieved in an automated manner. The extent of the folding down, which already takes place at the transport apparatus 31, and the extent of the remaining folding down, which is performed during the movement in the packaging machine 27, may generally vary as desired so that the portion supports 41 may possibly also be transferred to the packaging machine 27 already completely folded down and the packaging machine 27 may only have the hold-down device 77. Furthermore, the motion link 73 and the fold-down link 75 may in particular be formed in one part and together form a folding link by means of which the marginal section 45 may be continuously and completely folded down during a transport along the transport direction T, starting from a planar orientation of the portion support 41.

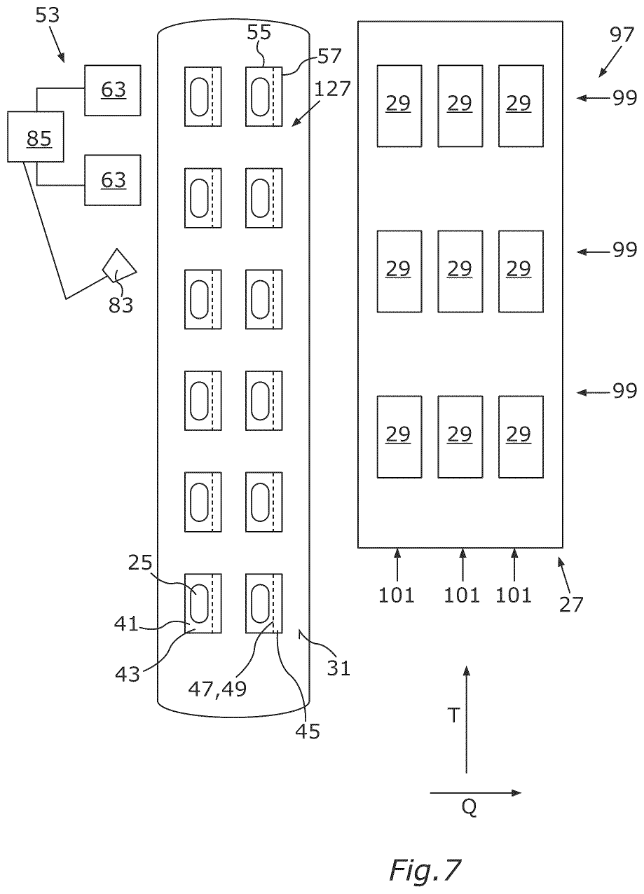

FIG. 7 illustrates that the packaging machine 27 may in particular be configured to provide a format 97 comprising a total of nine packaging spaces 29 during a cycle, wherein the packaging spaces 29 are arranged in three rows 99 and three columns 101. The insertion device 53 may be configured to fill the nine packaging spaces 29 with respective portion supports 41 and placed portions 25 during a cycle of the packaging machine 27, for which purpose the insertion device 53 may by way of example have two robot grippers 63 that may alternately insert five or four portions 25 in a respective cycle. As an example, the portion supports 41 in FIG. 7 are already shown in an orientation at the transport apparatus 31 and the insertion section 127 in which the bending lines 49 are aligned in parallel with the transport direction T so that the robot grippers 63 may bring the portion supports 41 and the placed portions 25 onto the packaging spaces 29 without having to rotate the portion supports 41. However, in embodiments in which the insertion device 53 comprises the turning device 81, it may also be provided that the packaging machine 27 is configured to provide such a format 97.

As again in particular shown in FIG. 1A, the packaging machine 27 may further have a separating device 190 that is configured to separate consecutive rows 99 of sealed packaging places 29 from one another, for which purpose the separating device 190 may in particular have a blade movable in a direction perpendicular to the transport direction T.

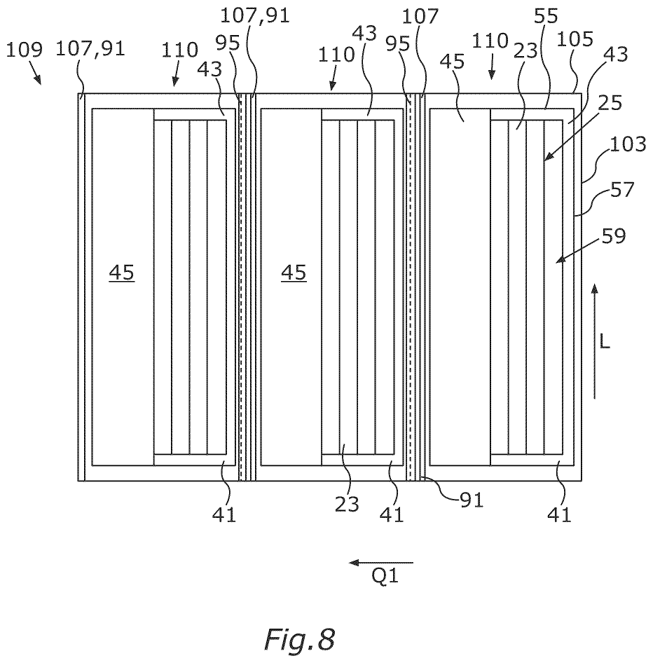

The system 11 may therefore in particular be configured to manufacture a food package arrangement 109 that is illustrated by means of FIG. 8 and that comprises three food packages 110 that are disposed next to one another in a transverse direction Q1 and that are connected to one another. The food packages 110 have a long side 103 extending along a longitudinal direction L and a short side 105 oriented perpendicular thereto and extending along the transverse direction Q1, wherein the portion supports 41 are inserted into the food package 110 such that the bending lines 49 of the portion supports 41 and their long sides 57 are aligned in parallel with the long sides 103 of the food packages 110. Furthermore, the marginal section 45 of a respective portion support 41 partly covers a portion upper side 59 of the associated portion 25.

Each of the food packages 110 is further formed with a respective reclosure 107, for example a zipper closure or a self-adhesive tape, that is arranged at a respective marginal section 91 of the food package 110. Furthermore, a perforation 95 is formed between two food packages 110 disposed next to one another so that the individual food packages 110 of the food package arrangement 109 may be conveniently separated from one another. As already explained, the manufacture of such a food package arrangement 109 is in particular made possible in that the insertion device 53 is configured to insert the portion supports 41 into the packaging machine 27 such that the bending lines 49 are aligned in parallel with the transport direction T since it is only thereby made possible to limit the extent of the food arrangement 109 in the transverse direction Q to a manageable dimension for a packaging machine 27.

### REFERENCE NUMERAL LIST

11 system
13 food product
15 cutting apparatus
17 product feed
19 gripper
20 guide
21 blade
23 slice
25 portion
27 packaging machine
29 packaging space
31 transport apparatus
33 transporting belt
34 feed
35 transport device
37 transport path
38 removal device
39 provision device
40 stack
41 portion supports
43 placement section
45 marginal section
46 margin
47 fold
49 bending line
51 folding device
53 insertion device
55 short side
57 long side
59 portion upper side
61 portion underside
63 robot gripper
65 bending device
67 web
69 holding edge
70 gripper element
71 contact section
72 contact section
73 motion link
75 fold-down link
77 hold-down device
79 portion support device
80 vacuum device
81 turning device
83 monitoring device
85 evaluation and control device
87 device
89 reclosure element
91 marginal section
93 perforating device
95 perforation
97 format
99 row
101 column
103 long side
105 short side
107 reclosure
109 food package arrangement
110 food package
111 material web
113 upper material web
115 molding station
117 sealing station
119 separating station
121 roller
123 roller
125 track
126 track
127 insertion section
D rotation
L longitudinal direction
Q transverse direction
Q1 transverse direction
S cutting plane
T transport direction

1. A system for processing food products, comprising:
at least one cutting apparatus that comprises:
a product feed; and
at least one blade arranged in a cutting plane, wherein the product feed is configured to guide food products on one track or on multiple tracks into the cutting plane,
wherein the at least one blade is configured to cut off slices from the food products that are guided into the cutting plane to obtain cut-off slices and to form a plurality of portions from the cut-off slices, each of the plurality of portions comprising one or more slices;
a packaging machine configured to provide a plurality of packaging spaces for the plurality of portions and to move the plurality of packaging spaces along a transport direction;
a transport apparatus that is configured to transport the plurality of portions from the at least one cutting apparatus along a transport path to the packaging machine;
a provision device that is arranged at the transport path and is configured to provide portion supports for the plurality of portions such that each of the plurality of portions transported by the transport apparatus along the transport path are placed on a placement section of a portion support,
wherein the portion support has a marginal section that is not covered by a portion of the plurality of portions when the portion is on the portion support, and
wherein a transition between the placement section and the marginal section of the portion support defines a bending line of the portion support;
a folding device that is configured to fold the portion support along the bending line; and
an insertion device that is configured to bring the portion support with the portion onto a packaging space of the plurality of packaging spaces such that the bending line of the portion support is aligned in parallel with the transport direction of the packaging machine.

2. The system according to claim 1, wherein the portion support is planar in a non-folded state prior to the folding device folding the portion support.

3. The system according to claim 1, wherein the portion support is at least substantially rectangular and/or at least substantially square.

4. The system according to claim 1,
wherein the portion support has a short side and a long side, wherein the bending line extends parallel to the long side.

5. The system according to claim 1,
wherein the bending line is formed by a fold; or
wherein the portion support is formed uniformly in a non-folded state and the bending line is defined by a predetermined spacing from an outer margin of the portion support, the outer margin facing away from the placement section.

6. The system according to claim 1,
wherein, in a folded state of the portion support, the marginal section of the portion support extends along a portion upper side that is opposite a portion underside with which the portion lies on the placement section.

7. The system according to claim 1,
wherein the insertion device is configured to bend the marginal section of the portion support by approximately or exactly 90 degrees during the insertion.

8. The system according to claim 1,
wherein the insertion device comprises a robot gripper that is configured to grip the plurality of portions that are transported by the transport apparatus into an insertion section and to bring the plurality of portions onto the plurality of packaging spaces,
wherein a bending device is arranged at the packaging machine,
wherein the robot gripper is configured to bring the marginal section of the portion support into contact with the bending device during the insertion of the portion, thereby bending the marginal section by approximately or exactly 90 degrees during the insertion.

9. The system according to claim 8,
wherein the robot gripper has a holding edge that fixes the bending line during the insertion.

10. The system according to claim 1,
wherein the insertion device and/or the transport apparatus comprises a transport device, and
wherein the folding device has a motion link which is arranged at the transport device and by which the marginal section of the portion support is pivotable during transport.

11. The system according to claim 10,
wherein the plurality of portions is transferable from the transport device to the packaging machine and are configured to be brought onto the plurality of packaging spaces.

12. The system according to claim 1,
wherein the folding device has a fold-down link that is arranged at the packaging machine and that is configured to fold down the marginal section of the portion support during the transport along the transport direction.

13. The system according to claim 1,
wherein the packaging machine has a hold-down device that is configured to counteract an unfolding of the portion support during the transport of the plurality of packaging spaces.

14. The system according to claim 1,
wherein the packaging machine has a portion support device that supports each of the plurality of portions at a portion underside.

15. The system according to claim 1,
wherein the provision device is configured to provide the portion support in first orientation in which the bending line is oriented perpendicular to the transport direction of the packaging machine, and
wherein the system further comprises a turning device that is configured to rotate the portion supports into second orientation in which the bending line of the portion support is aligned in parallel with the transport direction of the packaging machine.

16. The system according to claim 15,
wherein the turning device comprises the insertion device and is configured to rotate the portion support together with the portion during the insertion.

17. The system according to claim 15,
wherein the turning device comprises the transport apparatus and is configured to rotate the portion support together with the portion during transport.

18. The system according to claim 1,
wherein the system comprises a monitoring device that is configured to detect defective portions and incorrectly placed portions.

19. The system according to claim 18, further comprising:
an evaluation and control device that is configured to flag a second portion protruding laterally beyond a portion support of the plurality of portion supports as a defective portion or as an incorrectly placed portion depending on a degree of protrusion of the incorrectly placed portion laterally beyond the portion support.

20. The system according to claim 18,
wherein the insertion device is configured not to bring a defective portion onto a packaging space and/or to correct an orientation of an incorrectly placed portion during the insertion.

21. The system according to claim 1,
wherein the packaging machine is configured to manufacture reclosable packages.

22. The system according to claim 1,
wherein the packaging machine has a device for attaching a reclosure element,
wherein the device for attaching the reclosure element is configured to attach the reclosure element along the transport direction to the marginal section of a package.

23. The system according to claim 22,
wherein the reclosure element is configured as a self-adhesive tape or as a zipper closure.

24. The system according to claim 1,
wherein the packaging machine is configured to simultaneously provide at least two packaging spaces that are offset from one another perpendicular to the transport direction and to move the at least two packaging spaces along the transport direction, and
wherein the packaging machine has a perforating device that is configured to produce a perforation along the transport direction between the at least two packaging spaces.

25. The system according to claim 1,
wherein the packaging machine has three tracks and is configured to simultaneously provide three packaging spaces that are offset from one another perpendicular to the transport direction and to move the three packaging spaces along the transport direction.

26. The system according to claim 1,
wherein the packaging machine is configured for a cyclical operation and is configured to provide a format of packaging spaces in each cycle,
wherein the format of packaging spaces includes nine, twelve, or sixteen packaging spaces,
wherein the packaging spaces are arranged in:
three columns and three rows; or
in three columns and four rows; or
in four columns and three rows; or
in four columns and four rows, and
wherein the insertion device is configured to bring nine portions, twelve portions or sixteen portions onto the packaging spaces during a cycle.

27. A method for manufacturing a food package or a food package arrangement, comprising:
cutting slices off from a food product and forming a plurality of portions that each comprise one or more slices;
transporting the plurality of portions along a transport path and placing each of the plurality of portions on a placement section of a portion support of a plurality of portion supports during transport such that a marginal section of the portion support protrudes beyond a portion placed thereon and is not covered by the portion,
wherein the portion support is folded along a bending line, and
wherein the marginal section is folded down onto a portion upper side by the folding; and
inserting the portions together with the portion supports into or onto packaging spaces provided by a packaging machine such that the bending lines of the plurality of portion supports are aligned in parallel with a transport direction along which the packaging machine moves the packaging spaces.

28. The method according to claim 27,
wherein each portion support is provided in an orientation in which the bending line is oriented perpendicular to the transport direction of the packaging machine, and
wherein each portion support is rotated after the portions are placed on the portion support such that the bending lines are aligned in parallel with the transport direction.

29. The method according to claim 27,
wherein the marginal section is folded by approximately or exactly 90 degrees during the folding in a first step and is completely folded down in a second step; or
wherein the marginal section is continuously folded down during the folding.

30. The method according to claim 27,
wherein each portion support is folded during the insertion and/or during the transport.

31. The method according to claim 27,
wherein a reclosure element extending along the transport direction is attached to the food package.

32. The method according to claim 27,
wherein a row of three packaging spaces that are offset from one another perpendicular to the transport direction and that are connected to one another is simultaneously provided by the packaging machine,
wherein a respective portion placed on an associated portion support is brought onto each of the three packaging spaces of the row.

33. The method according to claim 32,
wherein a perforation extending along the transport direction is formed between the packaging spaces of the row.

34. The method according to claim 32,
wherein consecutive rows are separated from one another after the insertion of the portions and the consecutive rows are output as respective food package arrangements (109) comprising three mutually connected food packages.

35. The method according to claim 27,
wherein consecutively fed products are continuously sliced, and
wherein one or more portions are sorted out that comprise slices of an end piece of a product.

36. The method according to claim 27, further comprising:
correcting a misalignment of one or more portions placed on a respective portion support.

37. The method according to claim 27,
wherein the method is automatically performed.

38. A food package arrangement comprising:
a food package, comprising:
a portion is packaged that is arranged on a portion support and that comprises one or more slices of a food product,
wherein the portion support is folded along a bending line and has a folded-down marginal section that at least sectionally covers a portion upper side of the portion,
wherein a portion underside facing away from the portion upper side lies on a placement section of the portion support,
wherein the food package has a long side extending along a longitudinal direction and a short side extending along a transverse direction, wherein the bending line of the portion support (41) extends parallel to the longitudinal direction.

39. The food package arrangement according to claim 38,
wherein the food package has a reclosure that extends parallel to the bending line of the portion support.

40. The food package arrangement according to claim 38, wherein the food package is a first food package and further comprising a second food package and a third food package,
wherein the first food package, the second food package, and the third food package are mutually connected, and
wherein the transverse direction of each of the first food package, the second food package, and the third food package are aligned in parallel with one another and the first food package, the second food package, and the third food package_are arranged next to one another in the transverse direction.

41. The food package arrangement according to claim 40,
wherein a perforation extending along the longitudinal direction (L) is provided between two food packages disposed next to one another.

42. The food package arrangement according to claim 40,
wherein each of the first food package, the second food package, and the third food package has a respective reclosure that extends parallel to the bending line of the portion support.

43. The food package arrangement according to claim 39,
wherein the reclosure is configured as a self-adhesive tape or as a zipper closure.

44. The food package arrangement according to claim 38,
wherein the food package is manufactured by a method according to claim 27.

45. The food package arrangement according to claim 38,
wherein the food package is a first food package and the food package arrangement further comprises a second food package and a third food package, and
wherein the transverse direction of each of the first food package, the second food package, and the third food package is aligned in parallel with one another and the second food package is between the first food package and the third food package in the transverse direction.

46. The food package arrangement according to claim 45,
wherein a perforation extends along the longitudinal direction between the first food package and the second food package and between the second food package and the third food package.

47. The food package arrangement according to claim 45,
wherein each of the first food package, the second food package, and the third food package has a respective reclosure that extends parallel to the bending line of the packaged portion support.
